(19) United States
(12) Patent Application Publication
(10) Pub. No.: US 2016/0265231 A1
(43) Pub. Date: Sep. 15, 2016

(54) ADJUSTABLE AWNING TO FIT DIFFERENT SIZE STRUCTURES

(71) Applicant: George Gelsebach, Sherman Oaks, CA (US)

(72) Inventor: George Gelsebach, Sherman Oaks, CA (US)

(21) Appl. No.: 15/159,527

(22) Filed: May 19, 2016

Related U.S. Application Data
(63) Continuation of application No. 13/829,408, filed on Mar. 14, 2013, now abandoned.

(51) Int. Cl. E04F 10/02; E04H 15/54; E04H 15/58; F16M 13/02; E04F 10/08

(52) U.S. Cl. CPC E04F 10/02; F16M 13/02; E04F 10/08; E04H 15/58; E04H 15/54

(57) ABSTRACT

An apparatus, method, and kit for mounting to the wall of a structure. The apparatus comprises: first and second arms, each arm having an elongated portion and a mounting portion arranged at an angle relative to the elongated portion, the mounting portion defining one or more holes, the elongated portion of the first arm having a first inner surface, the elongated portion of the second arm having a second inner surface, first inner surface opposing the second inner surface; at least a first clamp member operably connected to the first arm and at least a second clamp member operably connected to the second arm; and at least one canopy member having a one end portion clamped between the first inner surface and the at least one clamp member and an opposite end portion clamped between the second inner surface and the at least second clamp member.

### REFERENCE TO COPENDING APPLICATIONS

This application is a continuation of U.S. Ser. No. 13/829,408 entitled ADJUSTABLE AWNING TO FIT DIFFERENT SIZE STRUCTURES filed Mar. 14, 2013, which are incorporated herein by reference in its entirety.

### TECHNICAL FIELD

This patent document relates generally to window awnings, and more particularly to an adjustable window awning.

### BACKGROUND

Awnings are commonly used over windows and doors to shade them from sunlight and protect them from rain and other precipitation. They typically consist of a fixed frame and a canopy sewn and fitted over the frame.

A difficulty is windows, doors, and other structures protected by awnings come in many different sizes and shapes. As a result, awnings are generally custom built to fit the structure it is shading and are custom installed. Such custom built awnings typically require additional labor costs and are expensive to manufacture—especially if the installer incorrectly measures the window or door. Custom awnings also can be difficult to install.

### SUMMARY

In general terms, this document relates to an awning to shade a structure such as windows or other openings of a home or a building. One aspect is an apparatus for mounting to the wall of the structure and shading a window. The apparatus comprises first and second arms wherein each arm has an elongated portion and a mounting portion arranged at an angle relative to the elongated portion. The mounting portion defines one or more holes. An elongated portion of the first arm has a first inner surface and the elongated portion of the second arm has a second inner surface. The first inner surface opposes the second inner surface. At least a first clamp member is operably connected to the first arm and a second clamp member is operably connected to the second arm. At least one canopy member has a one end portion clamped between the first inner surface and the at least one clamp member, and an opposite end portion clamped between the second inner surface and the at least second clamped member.

A second aspect is an awning assembly. The awning assembly comprises first and second arms, wherein each arm has a rear portion arranged for mounting to an outer wall of the structure and a leading portion oppositely disposed from the rear portion. Each arm comprises an inner surface and an outer surface, and two or more clamp members. The two or more clamp members are positioned proximally to the inner surface. The two or more canopy members treated to be at least water resistant. Each of the canopy members have a width in the range of about five inches to about eight inches. A first one of the two or more canopy members has one end clamped to the first arm between the inner surface and one of the two or more clamp members, and an opposite end clamped to the second arm between the inner surface and one of the two or more clamp members. A second one of the two or more canopy members has one end clamped to the first arm between the inner surface and another of the two or more clamp members, and an opposite end clamped to the second arm between the inner surface and another of the two or more clamp members. First and second side curtains are formed with a non-rigid material and each side curtain has a top portion and a rear portion. The first curtain is operably connected to the outer surface of the first arm and the rear portion is arranged to extend along the exterior wall of the structure. The second curtain is operably connected to the outer surface of the second arm and a rear portion is arranged to extend along the exterior wall of the structure. A first side curtain bracket member is operably connected to an inner surface of the first side curtain and the exterior wall of the structure, and a second side curtain bracket member is operably connected to an inner surface of the second side curtain and the exterior wall of the structure. At least one rigid elongated member has a first end operably connected to the leading portion of the first arm and an opposite end operably connected to the leading portion of the second arm.

Another aspect is a method for assembling an awning. The method comprises attaching first and second arms to an exterior wall of the structure and proximal to a window wherein each of the first and second arms comprise an elongated portion and a clamping member operably connected to the elongated portion; and clamping a first end portion of a canopy member between the elongated bracket and the clamp of the first arm and an opposite portion of the canopy member between the elongated portion and the clamp of the second arm.

Another aspect is a kit for assembling an awning and mounting the awning to the exterior wall of a structure. The kit comprises first and second arms wherein each arm has an elongated portion and a mounting portion arranged at an angle relative to the elongated portion. The mounting portion defines one or more holes. The elongated portion of the first arm has a first inner surface and the elongated portion of the second arm has a second inner surface wherein the first inner surface opposes the second inner surface. At least two clamp members configured for operable connection to the first arm and at least two clamp members configured for operable connection to the second arm. At least one canopy member is configured for clamping to the first and second arms.

### BRIEF DESCRIPTION OF THE DRAWINGS

FIG. 1 is a perspective view of an awning in use over a window.

FIGS. 2A and 2B are enlarged perspective views of first and second arms for the awning illustrated in FIG. 1.

FIG. 3 is a partial perspective view of the awing illustrated in FIG. 1 with a side curtain.

FIG. 4 is a perspective view of the awing illustrated in FIG. 1 with a side curtain and an elongated reinforcing member extending between the arms.

FIGS. 5A and 5B are cross sectional views taken along lines 5-5.

FIG. 6 is a partial bottom plan view of a canopy member illustrated in FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto.

Additionally, any examples set forth in the specification are not intended to be limiting and merely set forth some of the many possible embodiments for the appended claims.

Within this patent document, the conjunction “or” connotes “and/or” inappropriate. The indefinite articles “a” and “an” connotes “one or more” unless stated otherwise or the use of “one or more” is clearly inappropriate. Additionally, qualifiers such as “about” and “substantially” connotes physical structures, physical relationships, and values for given measurements, parameters, ranges, positions, and the like that can vary due to differences in manufacturing tolerances, conditions of use, and other factors.

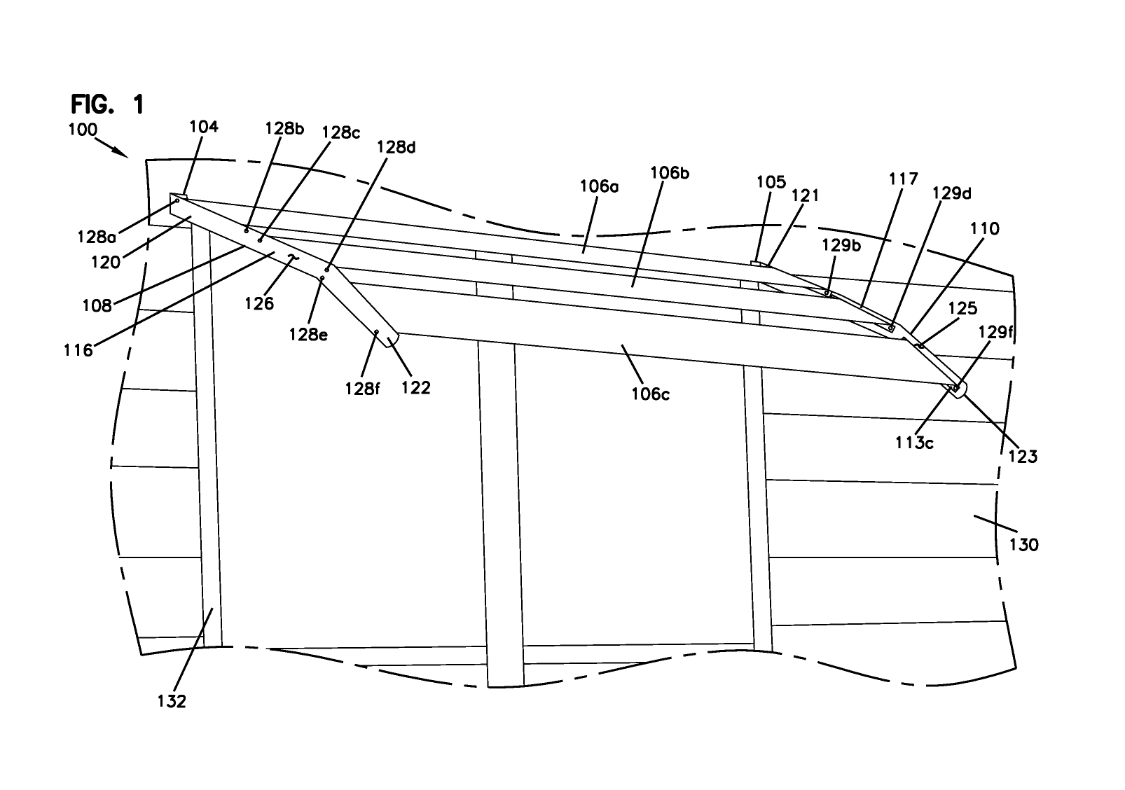

Referring to FIG. 1, an awning 100 includes first and second arms 108 and 110. One or more canopy members 106a-106c form a canopy and extend between, and are clamped to, the first and second arms 108 and 110. Each of the arms 108 and 110 is mounted on the exterior wall 130 of a structure proximal to a window 132 and positioned so that the canopy members 106a-106c protect the window 132 by providing shade or blocking rain. In other embodiments and installations, the awning 100 is positioned proximal to and protects other parts of a structure such as a door. The awning 100 also can be used indoors or on structures other than buildings such as recreational vehicles, campers, houseboats, etc.

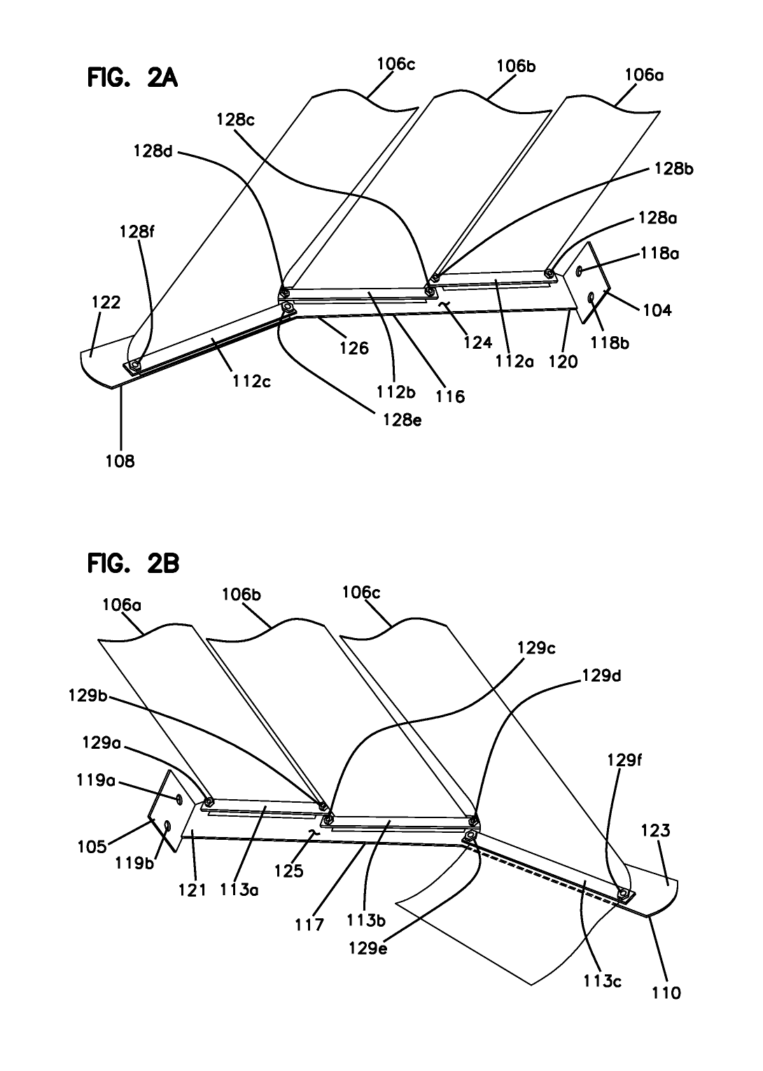

The first arm 108, as shown in FIG. 2A includes a mounting portion 104 and an elongated portion 116. The mounting portion 104 is arranged at an angle relative to the elongated portion 116 and is sized and configured to be placed against the outer surface of the structure's exterior wall 130. The mounting portion 104 defines two or more holes 118a and 118b sized to receive screws, bolts, or any other fasteners suitable for securely mounting the first arm 108 to the exterior wall 130.

The elongated portion 116 includes a proximal end portion 120 adjacent to the mounting portion 104 and an oppositely disposed distal end portion 122. The elongated portion 116 also includes an inner surface 124 and an outer surface 126. One or more clamping members 112a-112c are positioned to oppose the inner surface 124 and are configured to be drawn tight against the inner surface 124. In at least one possible embodiment, the clamping members 112a-112c are connected to the inner surface 124 with threaded rods such as bolts 128a-128f In at least one embodiment, there is one clamping member connected to the first arm 108 for each canopy member 106a-106c. For example, if the awning 100 has only one canopy member, there is only one clamping member connected to the first arm 108. If there are two canopy members, then there are two clamping members. There also can be more than three canopy members and clamping members.

In at least one possible embodiment, the length of the clamping members 112a-112c and the distance between the threaded fasteners 128a and 128b; 128c and 128d; 128e and 128f is at least longer than the corresponding canopy members 106a-106c, respectively, are wide. This sizing enables the canopy members 106a-106c to be securely clamped between the clamping members 112a-112c, respectively, and the inner surface 124 of the elongated portion 116 of the first arm 108 without being wrinkled, folded over, or caught in the bolt threads.

The canopy members 106a-106c and clamps 112a-112b are arranged such that clamp members 112a-112c extend along the length of the first arm 108 generally in the same direction. In various embodiments, the clamp members 112a-112c can be positioned parallel to one another, at angles relative to one another, parallel to the length of the first arm 108, at angles relative to the arm 108, or combinations thereof. Additionally, adjacent ends of the clamp members 112a and 112b, or 112b and 112c can be spaced along the length of the first arm 108 to form a gap between the adjacent ends of the clamp members 112a and 112b, and 112b and 112c, respectfully. Alternatively, the end of one clamp member can be positioned over or below the end of the adjacent clamp member. For example, the distal end of clamp member 112a could be positioned above the proximal end of the clamp member 112b to form a stair-step type of arrangement.

As shown in FIG. 2B, second arm 110 is a mirror image of first arm 108 and is substantially similar to first arm 108. Second arm 110 includes a mounting portion 105 sized to receive two or more holes 119a and 119b, an elongated portion 117 which includes an inner surface 125 and an outer surface (not shown), one or more clamping members 113a-113c, a distal end portion 123, a proximal end portion 121, and threaded rods such as bolts 129a-129f. Canopy members 106a-106c are attached between the clamp members 113a-113c and the second arm 110 similar to the first arm 108 as described herein.

Each of the canopy members 106a-106c is formed with any suitable material such as fabric or other types of sheeting. An example includes fabric such as canvas woven from acrylic, cotton, or polyester. Another example includes vinyl sheeting or vinyl laminated to fabric. Additionally, the canopy members 106a-106c can be woven or formed with threads, fibers, or yarn. Alternatively, they can be formed with a solid sheet of material. In at least some embodiments, the canopy members 106a-106c are non-rigid and compliant so they can be rolled or folded for packaging and shipping before the awning is mounted and assembled. Additionally, the materials forming the canopy members 106a-106c resist stretching to prevent them from sagging over time.

The end portion or other edges of the canopy members 106a-106c may be subject to fraying, especially if they are woven or otherwise formed with fibers. Fraying can be prevented by heating the end portions to melt or otherwise burn the edge of the fabric to resist fraying. In other alternatives, the edge portion of the canopy members 106a-106c can be stitched, folded over and attached to the surface of the canopy members 106a-106c similar to a hem, or treated with an adhesive or similar material. Additionally, the material forming the canopy members 106a-106c can be coated or otherwise treated with a material to make them water resistant or water proof. The material forming the canopy members 106a-106c also can be treated with material to protect against ultra-violet rays from the sun and fading. The material forming the canopy members 106a-106c also can be treated with material to protect against mildew and other types of mold.

In at least one possible embodiment, the canopy members 106a-106c are elongated and have a length substantially greater than their width. In one example, the width of the canopy members 106a-106c is in the range from about five inches to about eight inches. In another embodiment, the width of the canopy member is about 6.5 inches. In other examples, the canopy members 106a-106c have a width outside of this range. The width of the canopy members 106a-106c can depend on a variety of factors including the length of the arms and the number of canopy members 106a-106c that are included in the awning. Additionally, the canopy members 106a-106c can have a shape other than an elongated strip of material as described herein.

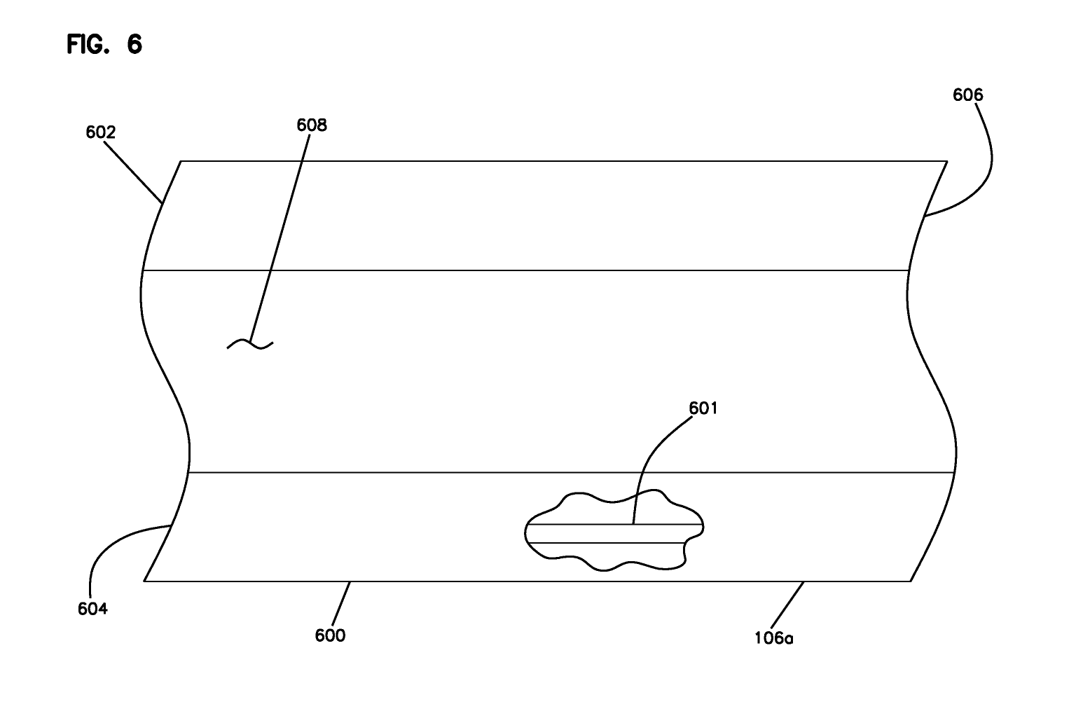

Referring now to FIG. 6, some alternative embodiments of the canopy member 106a includes an elongated member 601 positioned along both edge portions 600 and 602 to provide structural support and prevent the edge portions 600 and 602 of the canopy member 106a from sagging. In this embodiment, the edge portions 600 and 602 are folded over to form flaps 604 and 606, respectively, which are attached to the lower surface 608 of the canopy member 106a by any suitable structure such as stitching or adhesive. The elongated member 601 is enclosed between the flap 604 and the lower surface 608 of the canopy member 106a and extends substantially the entire length of the canopy member 106a. A second elongated member, not shown, is between the flap 606 and the lower surface 608 of the canopy member 106a. In some embodiments, the elongated member 601 is not so long that is will pass between the clamping members and the first and second arms 108 and 110. The elongated member 601 can be formed with any suitable material such as an elastic cord, nylon, wood, plastic, metal, etc. If an elastic cord is used, a possible embodiment has a diameter of about three quarters of an inch. Additionally, the elongated member 601 is formed with a material that can be easily cut or broken so it can be trimmed to length when the length of the canopy member 106a is set.

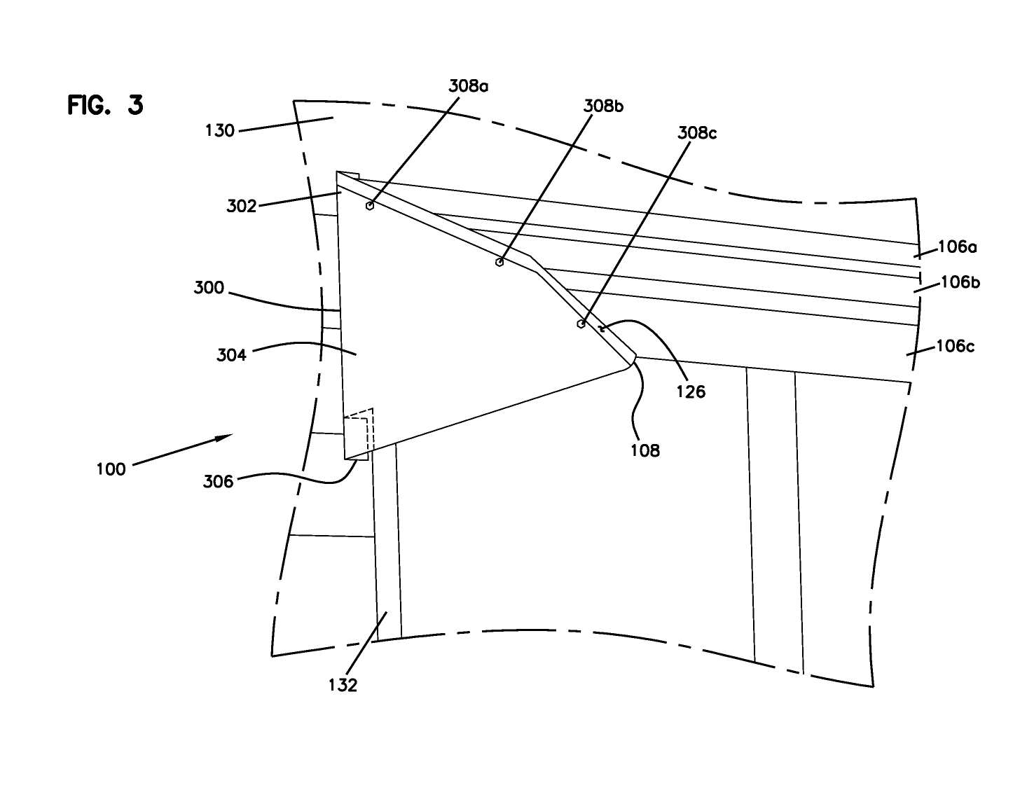

FIG. 3 illustrates an alternative embodiment of the awning assembly 100 mounted on the exterior wall 130 of a building. This embodiment is substantially similar to the embodiment illustrated in FIGS. 1 and 2 and includes first and second arms 108 and 110, canopy members 106a-106c, and clamping members 112a-112c and 113a-113c. Additionally, a first side curtain 300 includes a top portion 302 and a rear portion 304. The top portion 302 is positioned against the outer surface 126 of the first arm 108 and is attached thereto with a suitable fastener. Examples of suitable fasteners include threaded fasteners 308a-308c, clips, pins, rivets, adhesive, etc. An L-shaped bracket 306 is positioned between the rear portion 304 of the side curtain 300 and the exterior wall 130 of the building. The L-shaped bracket 306 can be connected to the first side curtain 300 with any suitable fasteners (not shown). Again, examples of suitable fasteners include threaded fasteners, clips, pins, rivets, adhesive, etc. Alternatively, the L-shaped bracket can be integrally formed into the rear portion 304 of the side curtain 300. Alternative embodiments use a bracket having a shape different than the L-shaped bracket 306 to attach the first side curtain 300 to the exterior wall 100 of the building. Yet other embodiments do not attach the rear portion 304 of the first side curtain 300 to the exterior wall 130 of the building. The first side curtain 300 is formed with any suitable rigid material such as fiberglass, plastic, aluminum, etc. The first side curtain 300 also can be formed with non-rigid materials such as those disclosed herein. Additionally, the first side curtain 300 can be formed with an opaque material, or with a transparent or semi-transparent material to let light or some light pass through the side curtain to the window. The first side curtain 300 also can be formed with a material that defines holes, or even a screen-like material, to let at least some light or at least some wind pass through the side curtain, which may reduce force applied to the side curtain and awning in especially windy areas. A second side curtain (not shown) is substantially similar to the first side curtain 300 and is connected to the second arm 110.

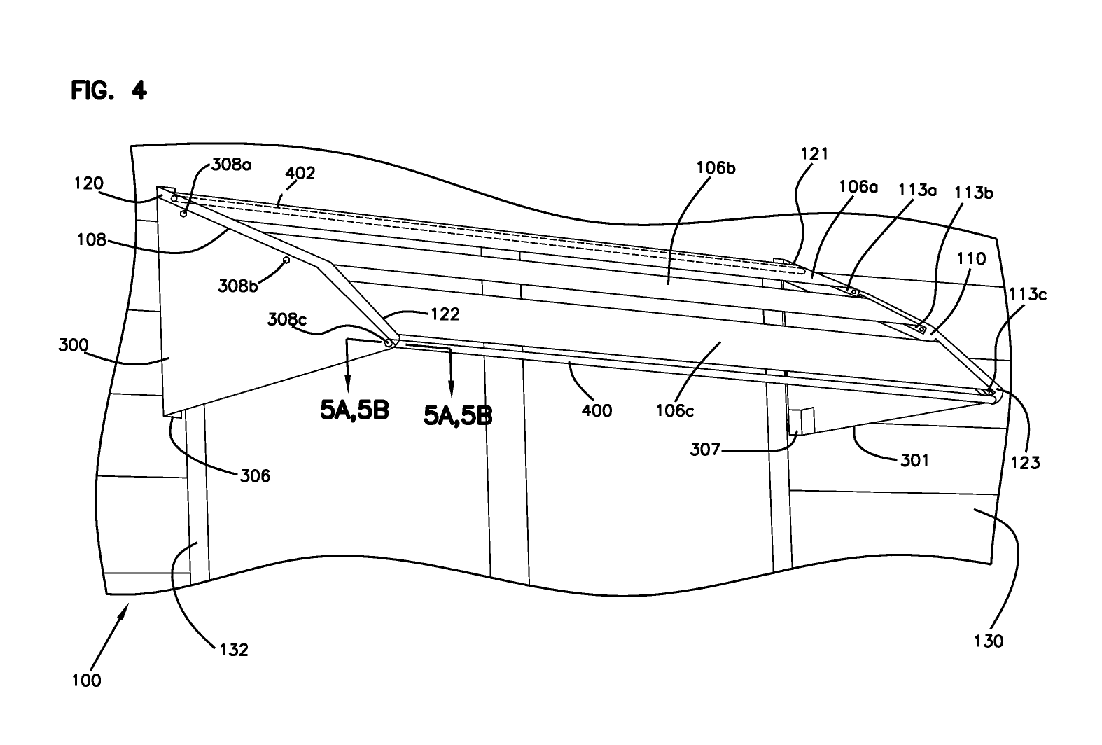

FIG. 4 illustrates another embodiment of an awning assembly 100 mounted on the exterior wall 130 of a structure proximal to a window 132. This embodiment is substantially similar to the embodiments illustrated in FIGS. 1-3 and includes first and second arms 108 and 110, canopy members 106a-106c, clamp members 112a-112c (not shown) and 113a-113c, side curtains 300 and 301, threaded fasteners 308a-308c, and L-shaped brackets 306 and 307. Additionally, a reinforcing member 400 is positioned between the distal end portion 122 of the first arm 108 and the distal end portion 123 of the second arm 110. The reinforcing member 400 is formed with any suitable material and structure that is substantially rigid. Examples of structures include tubular rods, solid rods, etc. Examples of materials include plastic such as polyvinyl chloride (PVC); metals such as iron, aluminum, steel; etc. A second reinforcing member 402 is substantially similar to reinforcing member 400 and may be positioned between the proximal end portion 120 of the first arm 108 and the proximal end portion 121 of the second arm 110. Alternative embodiments might include only a single elongated reinforcing member or more than two elongated reinforcing members.

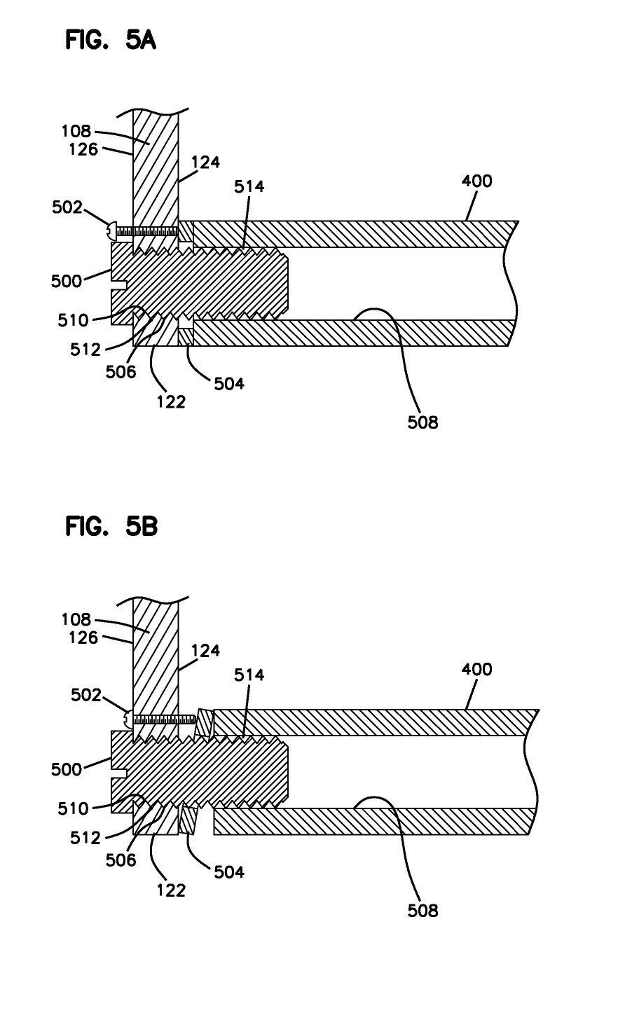

Referring to FIGS. 5A and 5B, the reinforcing member 400 can be connected to the first arm 108 using a peg 500. In this embodiment, the first arm 108 defines a hole 510 and threads 512 along the surface of the hole 510. The peg 500 has threads 514 passing through the hole 510 such that the treads 514 on the peg 500 and the threads 512 on the surface of the hole 510 mate. At least the end portion of the of the elongated reinforcing member 400 is tubular and defines a non-treaded, inner surface 508 having a diameter that is about equal to or slightly larger than the outer diameter of the threads 514 on the fastener. The end portion of the elongated reinforcing member 400 is then mounted on the threaded portion of the peg 500 using a friction fit rather than engaging the threads 514. Alternatively, the elongated reinforcing member 400 can be threaded to the peg 500. A washer 504 is positioned between the end of the elongated reinforcing member 400 and the first arm 108. Structures other than a threaded peg 500 can be used to connect the elongated reinforcing member 400 to the first arm 108 as illustrated herein. Examples of such other structures include a peg having no threads, a stub welded to or otherwise mounted on the inner surface 124 of the first arm 108. In yet other alternative embodiments, a tubular member, which may have a threaded or a smooth inner surface, is connected to the distal end portion 122 of the first arm 108 and the end portion of the elongated reinforcing member 400 fits within the tubular member. The opposite end of the elongated reinforcing member is similarly connected to the second arm 110 using a threaded peg and a washer. In other embodiments, no washer is positioned between the first and/or second arms 108 and 110 and the elongated reinforcing member 400.

Additionally, a threaded member such as a screw or bolt 502 is positioned adjacent to the peg 500 and threaded through the first arm 108. The screw 502 engages a surface of the washer 504. In use, the screw 502 can be rotated to urge it toward the washer 504 in a direction parallel to the elongated reinforcing member 400. Rotating and urging the screw 502 in this direction causes the washer 504 to skew relative to the first arm 108 and the elongated reinforcing member 400. This movement of the washer 504 causes the first arm 108 and the second arm 110 to elongate and form a gap there between, which pulls the canopy members 106a-106c tight and prevents them from sagging. A screw similar to screw 502 can be mounted to the second arm 110 in a similar fashion.

In use, the awning assembly 100 is assembled by attaching first and second arms 108 and 110 to an exterior wall 130 above the area or structure to be protected by the awning. In this example, the mounting portions 104 and 105 of the first and second arms 108 and 110 are attached to an exterior wall 130 above a window 132. The mounting portions 104 and 105 of arms 108 and 110, respectfully, are attached to the exterior wall 130 using suitable fasteners such as screws or bolts. Wall anchors can be used to securely hold the fastener in the wall. Once the first and second arms 108 and 110 are attached to the exterior wall, one end of the canopy member 106a is fed between the clamping member 112a and the first arm 108. The threaded fasteners 128a and 128b are tightened until the canopy member 106a is securely held between the clamping member 112a and the first arm 108. The canopy member 106a is then fed through the gap between the second clamp member 113a and the second arm 110. The canopy member 106a is pulled taught and the fasteners 129a and 129b are then tightened until the clamping member 113a is pulled tightly toward the second arm 110 and is securely holding the canopy member 106a in place. The end portions of the canopy member 106a may be cut or otherwise trimmed to length with scissors or a knife if they extend too far past the clamp members 112a and 112b (e.g. end of canopy member 106c extending past clamp member 113c as illustrated in FIG. 28). As discussed herein, the ends of the canopy can be treated to prevent fraying. This process of clamping canopy member 106a is repeated for each of the other canopy members 106b-106c.

If the elongated reinforcing member 400 is used, the peg 500 is threaded through the hole 510 in the distal end portion 122 of the first arm 108 until the head of the peg 500 engages the outer surface 126 of the first arm 108. The washer 504 is then placed on the peg 500 and the elongated reinforcing member 400 is slid over the peg 500. A second washer is then positioned between the opposite end of the elongated reinforcing member 400 and the second arm 110. A second peg is threaded through the second arm 110. This process is repeated for each of the elongated reinforcing members if more than one is used.

In various embodiments, the elongated reinforcing member 400 is attached to the first and second arms 108 and 110 after one or more of the canopy members 106a-106c are attached. This sequence of operations allows the reinforcing member 400 to be used as a lever to urge the first and second arms 108 and 110 apart to add tension to the canopy members 106a-106c and prevent sagging. Alternatively, the reinforcing member 400 is attached to the first and second arms 108 and 110 before the canopy members 106a-106c are attached. Additionally, in at least some alternative embodiments, the screw 502 is rotated after the first and second arms 108 and 110, canopy members 106a-106c, and elongated reinforcement member 400 are assembled to urge the first and second arms 108 and 110 apart to add tension to the canopy members 106a-106c.

If the awning assembly 100 is to include side curtains 300 and 301, they are connected to the first and second arms 108 and 110, respectively, using fasteners as described herein. Brackets 306 and 307 can be connected between the side curtains 300 and 301 and the exterior wall 130 of the structure also as described herein.

The awning assembly 100 may also be provided in a kit. In one possible embodiment, the kit includes arms 108 and 110, canopy members 106a-106c, clamp members 112a-112c, 113a-113c, and bolts. In various embodiments, the kit can include canopy members 106a-106c that are separated from one another. In other embodiments, the kit can include a single length of material for the canopy members 106a-106c that an installer can cut to length to form the separate canopy members 106a-106c. At least some alternative embodiments of a kit also can include various combinations of the side curtains 300 and 301, one or more reinforcing members 400, brackets 306 and 307, elongated reinforcing member(s) 400 and 402, washer(s) 507, screws or pegs 500, screw 502, wrenches or screw drivers for turning the various fasteners included in the kit, fasteners for mounting the first and second arms 108 and 110 to a wall 130, wall anchors, other various fasteners, screws, bolts, washers, adhesives, and hardware, etc.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. An apparatus for mounting to the wall of a structure, the apparatus comprising:
first and second arms, each arm having an elongated portion and a mounting portion arranged at an angle relative to the elongated portion, the mounting portion defining one or more holes, the elongated portion of the first arm having a first inner surface, the elongated portion of the second arm having a second inner surface, first inner surface opposing the second inner surface;
at least a first clamp member operably connected to the first arm and at least a second clamp member operably connected to the second arm; and
at least one canopy member having a one end portion clamped between the first inner surface and the at least one clamp member and an opposite end portion clamped between the second inner surface and the at least second clamp member.

2. The apparatus of claim 1 wherein the elongated portion for each of the first and second arms has a proximal portion adjacent to the mounting portion and an oppositely disposed distal portion, the apparatus further comprising:
at least one rigid elongated member having one end portion operably connected to the distal portion of the first arm and an opposite end operably connected to a the distal portion of the second arm.

3. The apparatus of claim 2, the apparatus further comprising:
at least a second rigid elongated member having one end portion operably connected to the proximal portion of the first arm and an opposite end operably connected to the proximal portion of the second arm.

4. The apparatus of claim 1 wherein the at least canopy member comprises canvas and is treated to make it at least water resistant.

5. The apparatus of claim 1 wherein each clamp member is an elongated bar and is connected to the inner surface of each arm.

6. The apparatus of claim 1 further comprising:
first and second side curtains;
the first curtain having a top portion operably connected to the first arm and a rear portion configured for positioning proximal to the wall of the structure; and
the second curtain having a top portion operably connected to the second arm and a rear portion configured for positioning proximal to the wall of the structure.

7. The apparatus of claim 6 wherein the first and second side curtains are formed with a substantially rigid material.

8. The apparatus of claim 6 wherein the rigid material is selected from the group consisting essentially of fiberglass, plastic, aluminum, or other polymeric or metallic materials.

9. The apparatus of claim 6 further comprising:
a first brace having a first portion operably connected to the first side curtain and a second portion configured for attaching to the side wall; and
a second brace having a first portion operably connected to the second curtain and a second portion configured for attaching to the side wall.

10. An awning assembly comprising:
first and second bracket assemblies, each bracket assembly comprising an arm having a rear portion arranged for mounting to an outer wall of a structure and a leading portion oppositely disposed from the rear portion, an inner surface and an outer surface and two or more clamp members, the two or more clamp members positioned proximally to the inner surface;
two or more canopy members treated to be at least water resistant, each of the canopy members having a width in the range of about six inches and about eight inches, wherein:
a first one of the two or more canopy members has one end clamped to the first arm between the inner surface and one of the two or more clamp members and an opposite end clamped to the second arm between the inner surface and one of the two or more clamp members; and
a second one of the two or more canopy members has one end clamped to the first arm between the inner surface and another of the two or more clamp members and an opposite end clamped to the second arm between the inner surface and another of the two or more clamp members;
first and second side curtains, each side curtain formed with a non-rigid material, each side curtain having a top portion and a rear portion, the first curtain operably connected to the outer surface of the first arm and a rear portion arranged to extend along the outer wall of the structure, the second curtain operably connected to the outer surface of the second arm and a rear portion arranged to extend along the outer wall of the structure;
a first side curtain bracket member operably connected to an inner surface of the first side curtain and the outer wall of the structure and a second side curtain bracket member operably connected to an inner surface of the second side curtain and the other wall of the structure; and
at least one rigid elongated member having a first end operably connected to the leading portion of the first bracket and an opposite end operably connected to the leading portion of the second bracket.

11. A method for assembling an awning, the method comprising:
attaching first and second arms to an exterior wall of a building and proximal to a window, each of the first and second arms comprising an elongated bracket and a clamping member operably connected to the elongated bracket; and
clamping a first end portion of a non-rigid material between the elongated bracket and the clamp of the first arm and an opposite portion of the non-rigid material between the elongated bracket and the clamp of the second arm.

12. The method of claim 11 wherein:
clamping a first end portion of a canopy member to the first arm comprises clamping the first end portion of a canopy member between the inner surface and clamping member of the first arm; and
clamping a second end portion of the canopy member to the second arm comprises clamping the second end portion of the canopy member between the inner surface and clamping member of the second arm.

13. The method of claim 12 further comprising:
if the first end portion of the canopy member extends all the way through the clamp to form excess material, trimming the excess material proximal to the first end portion; and
if the first end portion of the canopy member extends all the way through the clamp to form excess material, trimming the excess material proximal to the second end portion.

14. The method of claim 13 wherein the canopy member comprises canvas, the method further comprising:
heating the ends of the canopy member to prevent the canvas from fraying.

15. The method of claim 12 further comprising positioning an elongated member between a distal end of the first arm and a distal end of the second arm.

16. The method of claim 15 further comprising positioning an elongated member between a proximal end of the first arm and a proximal end of the second arm.

17. The method of claim 15 further comprising:
operably connecting a first side curtain to the first arm; and
operably connecting a second side curtain to the second arm.

18. A kit for assembling an awning and mounting the awning to the wall of a house, the kit comprising:
first and second arms, each arm member having an elongated portion and a mounting portion arranged at an angle relative to the elongated portion, the mounting portion defining one or more holes, the elongated portion of the first arm having a first inner surface, the elongated portion of the second arm having a second inner surface, first inner surface opposing the second inner surface;
at least two clamp members configured for operable connection to the first arm and at least two clamp members configured for operable connection to the second arm; and
at least one canopy member configured for clamping to the first and second arms.

19. The kit of claim 18 wherein the elongated portion for each of the first and second arms has a proximal portion adjacent to the mounting portion and an oppositely disposed distal portion, the kit further comprising:
at least one rigid elongated member having one end portion configured for operable connection to the distal portion of the first arm and an opposite end configured for operable connection to a the distal portion of the second arm.

20. The kit of claim 19 further comprising:
first and second side curtains;
the first curtain having a top portion configured for operable connection to the first arm and a rear portion configured for positioning proximal to the wall of the structure; and
the second curtain having a top portion configured for operable connection to the second arm and a rear portion configured for positioning proximal to the wall of the structure.
